(19) United States
(12) Patent Application Publication
(10) Pub. No.: US 2004/0202782 A1
(43) Pub. Date: Oct. 14, 2004

(54) METHODS FOR REPAIRING INSULATING MATERIAL

(75) Inventors: Mark Markovitz, Schenectady, NY (US); Peter John Foley, Glenville, NY (US); James Frank Armienti, Guilderland, NY (US); Ivan William Proctor, Scotia, NY (US); Robert Gerald Hamilton, Georgetown, MA (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(73) Assignee: GENERAL ELECTRIC COMPANY, Schenectady, NY (US)

(21) Appl. No.: 10/249,482

(22) Filed: Apr. 14, 2003

(51) Int. Cl. B32B 35/00

(52) U.S. Cl. 427/140

(57) ABSTRACT

A method for repairing insulation material applied to at least one electrical winding, wherein the method includes identifying an area to be repaired, applying epoxy to the area to be repaired, covering the epoxy with at least one of an adhesive tape and a release film, curing the epoxy, removing at least one of the adhesive tape and the release film, and finalizing the epoxy height.

### BACKGROUND OF INVENTION

This invention relates generally to electrical coils, and more particularly to methods for repairing insulating material used with electrical coils.

At least some known power generating systems include electromagnetic components such as generators that include rotor assemblies including insulated field electrical coils. In at least some known rotor assemblies, powder coat electrical insulation is electrostatically deposited on the field coils during manufacture of the electrical coils. The electrostatically deposited powder is baked to fuse the powder and cured to form an electrically insulating coating. After the insulation is cured, the coils are inspected to identify any bare spots in which the coils may not be adequately insulated, or any other areas of potentially damaged insulation. More specifically, such insulation defects are typically repaired to adequately protect the coils from electrical shorts and electrical grounds. However, the repairing the defects may cause the insulation to form tenacious bonds to the powder coat insulation and form a continuous insulation film.

Accordingly, repair techniques are typically used to facilitate restoring the integrity of the insulation. More specifically, within at least some known repair techniques, adhesives and strip insulation materials are manually applied to the bare spots and damaged areas. However, such procedures may be time-consuming, and such repair procedures may undesirably introduce dissimilar materials into the powder coat insulation. Furthermore, although the adhesives and strip insulation materials create a hybrid insulation system which has electrical and physical characteristics of both types of insulation, such repairs may actually decrease an overall resistance of the insulation to moisture absorption despite a potentially increased thickness of insulation in the repaired areas. Additionally, the use of adhesives and strip insulation materials can result in a discontinuity between the repair and the surrounding insulation which may weaken the repair.

### SUMMARY OF INVENTION

In one aspect, a method is provided for repairing insulation material applied to at least one electrical winding, wherein the method includes identifying an area to be repaired, applying epoxy to the area to be repaired, covering the epoxy with at least one of an adhesive tape and a release film, curing the epoxy, removing at least one of the adhesive tape and the release film, and finalizing the epoxy height.

In another aspect, a method is provided for repairing powder coat insulation material applied to field electric coils. The method includes identifying an area to be repaired, cleaning the area to be repaired and any powder coat insulation that is adjacent the area to be repaired, and applying repair material to the area to be repaired using a paint brush, wherein the material is substantially similar to the existing powder coat insulation. The method further includes covering the repair material area with at least one of an adhesive tape and a release film, curing the repair material, removing at least one of the adhesive tape and the release film, and removing the excess cured material from the repair area.

### BRIEF DESCRIPTION OF DRAWINGS

FIG. 1 is a side view of an exemplary embodiment of an electric generator.

FIG. 2 is a perspective view of an exemplary embodiment of an electric coil that may be used with the generator in shown in FIG. 1.

FIG. 3 is a cross-sectional view of an exemplary embodiment of the electric coil shown in FIG. 2.

FIG. 4 is a flow chart illustrating an exemplary method for repairing insulation used with the electric coil shown in FIG. 2.

### DETAILED DESCRIPTION

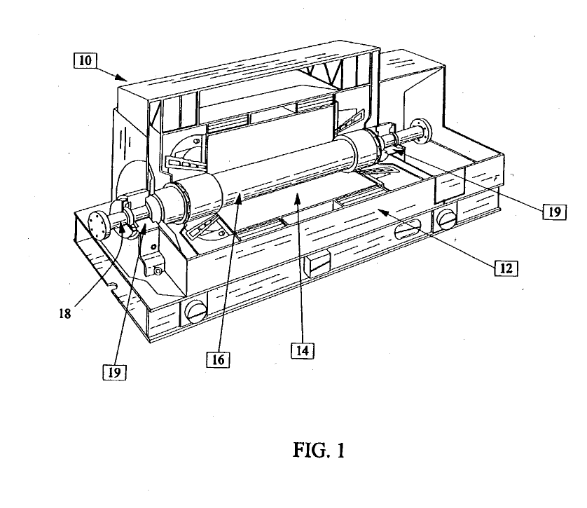

FIG. 1 is a side view of an exemplary embodiment of an electric motor 10. In one embodiment motor 10 is a motor commercially available from the GE Power Generating Systems business of General Electric Company, Schenectady, N.Y. Generator 10 includes a housing 12, a stator 14, and a rotor assembly 16. Stator 14 is mounted within housing 12 and includes a stator bore (not shown). Rotor assembly 16 is supported by a rotor shaft 18 that extends at least partially through the stator bore and circular holes 19 in housing 12. In one embodiment, rotor assembly 16 is mounted on rotor shaft 18 and includes at least two electrical coils (not shown in FIG. 1) that each include a plurality of windings (not shown in FIG. 1) disposed diametrically opposite a plurality of axial rotor body slots (not shown) and that represent respective generator field magnetic poles.

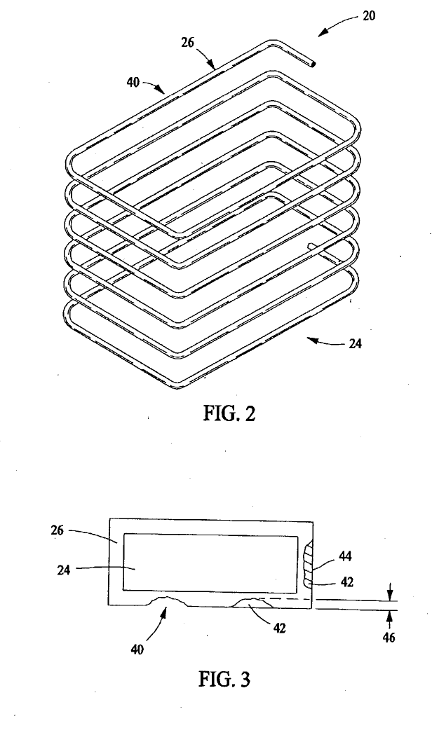

FIG. 2 is a perspective view of an exemplary embodiment of an electric coil 20 that may be used with generator 12 (shown in FIG. 1). FIG. 3 is a cross-sectional view of the exemplary embodiment of the electric coil 20 shown in FIG. 2. Electric coil 20 is electrically coupled the rotor shaft and includes a plurality of windings 24. Windings 24 are wound to form electrical coil 20. In one embodiment, winding 24 is fabricated from a substantially flat wire member. In one embodiment, windings 24 are fabricated from copper.

Each winding 24 is insulated by an insulating material 26 that circumscribes winding 24. In the exemplary embodiment, insulating material 26 is powder coat insulation. In one embodiment, the insulation material 26 is commercially available from Morton Powder Coatings, a Division of Rohm & Haas Co., Reading, Pa. Insulating material 26 facilitates isolating adjacent windings 24 from each other, and insulating each winding 24 from metal surfaces within the motor, as well as dirt and water.

During operation and/or manufacture, the insulation material 26 is inspected to identify any bare spots 40 in which windings 24 may not be adequately insulated, or any other areas of potentially damaged insulation. More specifically, such insulation 26 defects may not adequately protect the windings 24 from electrical shorts and electrical grounds.

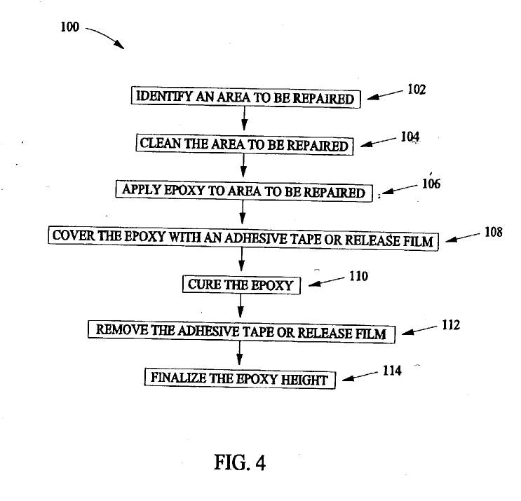

FIG. 4 is a flowchart 100 illustrating an exemplary method for repairing insulation material 26 (shown in FIGS. 2 and 3) used with electrical coil 20. Method includes identifying 102 an area to be repaired such as bare spot 40, cleaning 104 the area to be repaired and applying 106 an epoxy 42 to bare spot 40. In the exemplary embodiment, epoxy 42 is an epoxy resin that is a solventless, 100% reactive material having a Class F electrical insulation capability, wherein Class F electrical insulation capability refers to continuous operation at approximately 155° C. In one embodiment, epoxy 42 is fabricated by blending an epoxy resin with a hardener, also known as a curing agent. In another embodiment, epoxy 42 reacts at ambient temperatures, between approximately 50° F. and 90° F., such that no baking of epoxy 42 is required.

In one embodiment, epoxy 42 is a difunctional liquid bisphenol A-diglycidyl ether epoxy resin commercially available from Shell Chemical Co., Houston, Tex., such as but not limited to EPON® 826 with an epoxide functionality of 2, an epoxy equivalent weight between approximately 178 and 186, and a viscosity between approximately 6500 and 9500 cps at approximately 25° C., EPON® 828 with an epoxide equivalent weight between approximately 185 and 192 and a viscosity between approximately 11,000 and 15,000 cps at about 25° C., or EPON® 830 with an epoxide equivalent weight between approximately 190 and 198 and a viscosity between approximately 17,700 and 22,500 cps at about 25° C. Many other similar liquid bisphenol A-diglycidyl ether epoxy resins made by different manufacturers could also be foreseeably used.

In another embodiment, epoxy 42 is a difunctional liquid bisphenol A-diglycidyl ether epoxy resin such as but not limited to ARALDITE® GY 6008 commercially available from Vantico Inc., East Lansing, Mich., DER 330 commercially available from Dow Chemical Co., Midland, Mich. or EPOTUF® 37-139 commercially available from Reichhold Inc., Durham, N.C.

In an alternative embodiment, epoxy 42 is from a group of liquid bisphenol F-diglycidyl ether epoxy resins such as but not limited to EPON® DPL-862, commercially available from Shell Chemical Co. and having an epoxide equivalent weight between approximately 166 and 177 and a viscosity between approximately 3,000 and 4,500 cps at approximately 25° C., and bisphenol F-diglycidyl ether epoxy resins commercially available from Vantico Inc., such as but not limited to ARALDITE® GY 281 with an epoxide equivalent weight between approximately 158 and 175 and a viscosity between approximately 5,000 and 7,000 cps at approximately 25° C., or ARALDITE® GY 308 with an epoxide equivalent weight between approximately 173 and 182 and a viscosity between approximately 6,500 and 8,000 cps at approximately 25° C.

In another alternative embodiment, epoxy 42 includes epoxy novolac resins and cycloaliphatic epoxy resins commercially available from Dow Chemical Co., such as but not limited to DEN 431 with an epoxide equivalent weight between approximately 172 and 179 and a viscosity between approximately 76,500 cps at approximately 25° C., ERL-4206 with an epoxy equivalent weight between approximately 70 and 74 and a viscosity of less than approximately 15 cps at approximately 25° C., ERL-4221 or ERL-4221 E with an epoxy equivalent weight between approximately 131 and 143 and a viscosity between approximately 350 and 450 cps at approximately 25° C., ERL-4234 with an epoxy equivalent weight between approximately 133 and 154 and a viscosity between approximately 7,000 and 17,000 cps at approximately 38° C., or ERL-4299 with an epoxy equivalent weight between approximately 190 and 210 and a viscosity between approximately 550 and 750 cps at approximately 25° C. These cycloaliphatic epoxy resins may be manufactured by other suppliers.

The curing agent can be from the group including, but not limited to, aliphatic amines, amido amines, polyamides, modified or amine adducts, cycloaliphatic amines, acid anhydrides with accelerators for the epoxy acid anhydride cure reaction, boron fluouride-amine complexes, and other high reactivity hardeners that react with epoxy resins at room temperature. The epoxy resins can be modified with fillers to make the resin non-sagging by using submicron-fumed silica or other fillers such as aluminum oxide, pulverized mica and talc.

A dye can be used that changes color when the hardener and epoxy resin containing the dye are mixed. For example, an acidic dye that is neutralized by a basic amine hardener, may be used. In another embodiment, epoxy 42 is an epoxy resin containing a small quantity of a dye, i.e., less than approximately 0.1%, such that when the epoxy resin is mixed with the hardener, the color fades to act as an indicator that the epoxy resin and the hardener have been completely blended for optimum performance. In another embodiment, epoxy 42 is an epoxy resin containing a small quantity of a dye, i.e., less than approximately 0.05%. A dye can be used that changes color when the hardener and epoxy resin containing the dye are mixed, for example, an acidic dye that is neutralized by a basic amine hardener.

The method also includes covering 108 epoxy 42 with either an adhesive tape or release film 44. In one embodiment, tape 44 is a non-reacting tape. In the exemplary embodiment, adhesive tape 44 is silicone adhesive backed Mylar® tape. In another embodiment, adhesive tape 44 is polyvinyl floride such as (TEDLAR®, commercially available from DuPont. Wilmington, Del.). In another embodiment, adhesive tape 44 is tetrafluoro-ethylene such as (TEFLON®, commercially available from DuPont). The method also includes curing 110 epoxy 42, removing 112 either adhesive tape or release film 44, and finalizing 114 an epoxy height 46. In one embodiment, finalizing 114 an epoxy height 46 includes sanding epoxy 42 to a desired height. In one embodiment, finalizing 114 an epoxy height 46 includes sanding epoxy 42 to ensure epoxy 42 is substantially coplanar with the insulating material 26 adjacent to bare spot 40. In another embodiment, finalizing 114 an epoxy height 46 includes sanding epoxy 42 to ensure epoxy 42 is substantially coplanar with the insulating material 26 adjacent to bare spot 40 includes using a non-conductive 220-320 grit sandpaper comprising alumina abrasive particles.

The present invention is directed, in one aspect, to a generator that includes at least one copper field coil. Although one specific embodiment of copper field coils is described below, it should be understood that the present invention can be utilized in combination with many other coils and is riot limited to practice with copper coils described herein. The present invention, however, is not limited to practice with just copper coils and can be used with many other types of metallic surfaces. The present invention provides for a novel method for applying insulating material to the copper field coils of a generator which is efficient, cost-effective, reliable, and maybe employed with minimum labor.

While the invention has been described in terms of various specific embodiments, those skilled in the art will recognize that the invention can be practiced with modification within the spirit and scope of the claims.

1. A method of repairing insulation material applied to at least one electrical winding, said method comprising:
identifying an area to be repaired;
applying epoxy to the area to be repaired;
covering the epoxy with at least one of an adhesive tape and a release film;
curing the epoxy;
removing at least one of the adhesive tape and the release film; and
finalizing the epoxy height.

2. A method in accordance with claim 1 further comprising cleaning the area to be repaired and insulation material that is adjacent to the area repaired prior to applying the epoxy.

3. A method in accordance with claim 2 wherein cleaning the repair area and the surrounding insulation material comprises using an abrasive pad.

4. A method in accordance with claim 1 wherein finalizing the height comprises ensuring the epoxy is substantially planar with insulating material adjacent to the area to be repaired.

5. A method in accordance with claim 1 wherein applying an epoxy to at least one repair area comprises applying the epoxy using an acid free paintbrush.

6. A method in accordance with claim 1 wherein applying an epoxy to the area to be repaired comprises applying an epoxy having a Class F electrical insulation capability to the area to be repaired.

7. A method in accordance with claim 1 wherein covering the epoxy with an adhesive tape comprises covering the epoxy with a silicone adhesive backed tape.

8. A method in accordance with claim 1 wherein covering the epoxy with an adhesive tape to facilitate substantially flattening the epoxy.

9. A method in accordance with claim 1 further comprising removing excess epoxy from the edges of at least one of the adhesive tape and the release film.

10. A method in accordance with claim 1 wherein finalizing the epoxy height comprises sanding the epoxy to a desired height.

11. A method in accordance with claim 1 wherein finalizing the epoxy height comprises removing a portion of cured epoxy material using non-inductive sandpaper.

12. A method in accordance with claim 1 finalizing the epoxy height comprises removing a portion of cured epoxy material to facilitate providing a repaired area that is substantially identical to area of insulation adjacent to the repaired area.

13. A method of repairing powder coat insulation material applied to field electric coils, said method comprising:
identifying an area to be repaired
cleaning the area to be repaired and any powder coat insulation that is adjacent the area to be repaired;
applying repair material to the area to be repaired using a paint brush,
wherein the material is substantially similar to the existing powder coat insulation;
covering the repair material area with an at least one of an adhesive tape and a release film;
curing the repair material;
removing at least one of the adhesive tape and the release film; and
removing the excess cured material from the repair area.

14. A method in accordance with claim 13 wherein removing the excess cured material from the repair area comprises sanding the cured material to a desired height.

15. A method in accordance with claim 13 wherein cleaning the area to be repaired comprises using an abrasive pad to clean the area to be repaired and any insulation adjacent to the area to be repaired.

16. A method in accordance with claim 13 wherein applying repair material comprises applying an epoxy having a Class F electrical insulation capability to the area to be repaired.

17. A method in accordance with claim 13 wherein applying repair material to the area to be repaired comprises using an acid free paint brush to apply the material to the area.

18. A method in accordance with claim 13 wherein removing excess cured material from the area to be repaired comprises using non-conductive sandpaper to remove the excess cured material.

19. A method in accordance with claim 13 wherein removing excess cured material comprises sanding the cured material such that an outer surface of the cured material is substantially coplanar with an outer surface of insulating material that is adjacent the repair area.

20. A method in accordance with claim 13 further comprising removing excess material from the edge of at least one of the adhesive tape and the release film.
